(19) United States
(12) Patent Application Publication
(10) Pub. No.: US 2004/0257349 A1
(43) Pub. Date: Dec. 23, 2004

(54) Display apparatus

(75) Inventor: Hiroshi Kobayashi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/819,302

(22) Filed: Apr. 7, 2004

(30) Foreign Application Priority Data
Apr. 8, 2003 (JP) 2003-103764

(51) Int. Cl. G09G 5/00

(52) U.S. Cl. 345/204

(57) ABSTRACT

A display apparatus of the dot-sequential driving type which can be improved against display defects of a ghost and a vertical stripe is disclosed. Sampling switches are separated into a first group wherein the sampling switches are disposed at intervals and a second group wherein the sampling switches are disposed in a relationship offset by a one-switch distance from the sampling switches of the first group. Image lines of a first system are connected to the sampling switches of the first group while image lines of a second system are connected to the sampling switches of the second group. A train of sampling pulses successively outputted from a horizontal driving circuit is distributed alternately to the sampling switches which belong to the first group and the sampling switches which belong to the second group to form a first pulse train and a second pulse train, respectively. Adjacent ones of the sampling pulses in the first pulse train are non-overlapping sampling pulses and adjacent ones of the sampling pulses in the second pulse train are non-overlapping sampling pulses while a sufficient pulse width is assured for the sampling pulses so that the image signal is sampled appropriately.

### BACKGROUND OF THE INVENTION

This invention relates to a display apparatus, and more particularly to improvements in or relating to a horizontal driving circuit built in an active matrix display apparatus of the dot-sequential driving type.

FIG. 15 is a block diagram showing an example of a typical configuration of a conventional display apparatus. Referring to FIG. 15, the conventional display apparatus shown includes a panel 33 in which a pixel array section 15, a vertical driving circuit 16, a horizontal driving circuit 17 and other necessary circuits not shown are formed in an integrated manner. The pixel array section 15 includes gate lines 13 extending along rows, signal lines 12 extending along columns and pixels 11 disposed in rows and columns at intersecting points of the gate lines 13 and the signal lines 12. The vertical driving circuit 16 is disposed divisionally on the opposite left and right sides of the pixel array section 15 and connected to the opposite ends of the gate lines 13 to successively select the rows of the pixels 11. The horizontal driving circuit 17 is connected to the signal lines 12 and operates in response to a clock signal of a predetermined period to successively write an image signal into the pixels 11 of the selected row. The conventional display apparatus further includes an external clock production circuit 18 which generates clock signals HCK and HCKX which are used as a reference to operation of the horizontal driving circuit 17 and clock signals DCK1 and DCK2 having an equal period to but having a lower duty ratio than those of the clock signals HCK and HCKX. It is to be noted that the clock signal HCKX is an inverted signal of the clock signal HCK. Further, though not described particularly herein, also inverted signals DCK1X and DCK2X of the clock signals DCK1 and DCK2 are supplied as occasion demands. The external clock production circuit 18 supplies the clock signals and a horizontal start pulse HST to the panel 33 side. It is to be noted that a precharge circuit 20 is connected to the signal lines 12 such that it performs precharge of the signal lines 12 preceding to writing of an image signal to improve the picture quality.

[Patent Document 1] Japanese Patent Laid-Open No. 2000-267616

FIG. 16 is a circuit diagram showing an example of a configuration of the display apparatus shown in FIG. 15. Referring to FIG. 16, the display apparatus is composed of a panel which includes gate lines 13 extending along rows, signal lines 12 extending along columns, pixels 11 disposed in rows and columns at intersecting points of the gate lines 13 and the signal lines 12, and an image line 25 for supplying an image signal. The display apparatus includes a vertical driving circuit 16, a horizontal driving circuit 17 and a clock production circuit 18 in addition to the panel described above. Typically, the vertical driving circuit 16 and the horizontal driving circuit 17 are built in the panel. Also a sampling switch set 23 is formed in the panel. Each switch (HSW) of the sampling switch set 23 is disposed in a corresponding relationship to an individual one of the signal lines 12 and acts to connect the image line 25 to the signal line 12.

The vertical driving circuit 16 is connected to the gate lines 13 and sequentially selects the pixels 11 in a unit of a row. The horizontal driving circuit 17 operates in response to a clock signal of a predetermined period to successively generate sampling pulses A′, B′, C′, D′, . . . to successively drive the switches HSW of the sampling switch set 23 thereby to select a row of the pixels 11 into which an image signal is to be successively written.

The clock production circuit 18 produces a clock signal HCK which is used as a reference to operation of the horizontal driving circuit 17 and produces clock signals DCK1 and DCK2 having a smaller pulse width than that of the clock signal HCK. Meanwhile, the horizontal driving circuit 17 includes a shift register 21 and an extracting switch set 22. It is to be noted that each of the stages of the shift register 21 is denoted by S/R. The shift register 21 performs a shifting operation of the horizontal start pulse HST in synchronism with the clock signal HCK to successively output shift pulses A, B, C, D, . . . from the successive shift stages S/R thereof. The switches of the extracting switch set 22 extract the clock signals DCK1 and DCK2 in response to the shift pulses A, B, C, D, . . . successively outputted from the shift register 21 to successively produce sampling pulses A′, B′, C′, D′, . . . described hereinabove.

Operation of the display apparatus shown in FIG. 16 is described briefly with reference to FIG. 17. The horizontal driving circuit 17 operates in response to the clock signal HCK (which may be hereinafter referred to suitably as HCK pulse) and the clock signal HCKX which is an inverted signal of the clock signal HCK to successively transfer the horizontal start pulse HST to produce shift pulses A, B and C. The clock production circuit 18 supplies the HCK pulse and the clock signals DCK1 and DCK2 (which may be hereinafter referred to suitably as DCK pulses) to the horizontal driving circuit 17. As apparently seen from the timing chart of FIG. 17, while the DCK pulses have a period equal to that of the CHK pulse, they have a smaller pulse width than that of the CHK pulse. Further, the clock signals DCK1 and DCK2 have phases displaced by 180 degrees from each other.

The horizontal driving circuit 17 drives the extracting switch set 22 to open and close with the shift pulses A, B and C to extract DCK pulses. Then, the horizontal driving circuit 17 produces the sampling pulses A′, B′and C′ from the extracted DCK pulses. More particularly, a pulse of the DCK pulse DCK1 is extracted with the shift pulse A to produce the sampling pulse A′. Similarly, a pulse of the DCK pulse DCK2 is extracted with the shift pulse B to produce the sampling pulse B′. Such a clock drive method as just described is employed so that mutually adjacent sampling pulses may not overlap with each other. In other words, the sampling pulses A′ and B′ are spaced from each other in time and do not overlap with each other at all. Also the sampling pulses B′ and C′ are spaced from each other in time and do not overlap with each other at all.

One of subjects to be solved with regard to an active matrix display apparatus of the dot sequential driving type conventionally resides in display defects such as a ghost and a vertical stripe. The ghost is produced through sampling of an image signal, which is to be sampled to an adjacent signal line, to the pertaining signal line because of a dispersion or a delay of an output timing of a sampling pulse. In order to suppress the ghost, it is effective to assure the distance between adjacent sampling pulses (that is, a non-overlapping period of time) as long as possible. However, as the non-overlapping period of time increases, the width of the sampling pulses decreases as much. On the other hand, a vertical stripe is caused by an error in display density between pixels of adjacent columns when the width of the sampling pulse is dispersed or fluctuated to make sampling of a video signal with respect to a signal line less sufficient or less complete. In order to suppress a vertical stripe, it is preferable to take the sampling pulse width as great as possible. However, as the sampling pulse width increases, the non-overlapping period of time decreases as much.

In order to suppress the ghost, it is effective to assure a great non-overlapping period of time, and in order to suppress a vertical stripe, it is effective to assure a great pulse width. However, the two conditions have a tradeoff relationship to each other, and if it is tried to improve one of the conditions, then it is obliged to sacrifice the other condition.

### SUMMARY OF THE INVENTION

It is an object of the present invention to provide a display apparatus of the dot-sequential driving type which can be improved by moderating display defects of a ghost and a vertical stripe.

In order to attain the object described above, according to an aspect of the present invention, there is provided a display apparatus, comprising a panel including a plurality of gate lines extending along rows, a plurality of signal lines extending along columns, a plurality of pixels arranged in a matrix at intersecting points at which the gate lines and the signal lines intersect with each other, and a plurality of image lines separated into two or more systems for supplying an image signal, a vertical driving circuit connected to the gate lines for successively selecting the rows of the pixels, a plurality of sampling switches disposed for connecting the signal lines to the image lines, and a horizontal driving circuit operable in response to a clock signal for successively generating sampling pulses to successively drive the sampling switches so that the image signal is successively written into the pixels of the selected row, the sampling switches being grouped into a first group wherein the sampling switches are disposed at intervals and a second group wherein the sampling switches are disposed in a relationship offset by a one-switch distance from the sampling switches which belong to the first group, the image lines of a first one of the systems being connected to the sampling switches of the first group while the image lines of a second one of the systems being connected to the sampling switches of the second group, a train of the sampling pulses successively outputted from the horizontal driving circuit being distributed alternately to the sampling switches which belong to the first group and the sampling switches which belong to the second group to form a first pulse train and a second pulse train, respectively, the sampling pulses in the first pulse train and the second pulse train being set such that adjacent ones of the sampling pulses in the first pulse train are non-overlapping sampling pulses and adjacent ones of the sampling pulses in the second pulse train are non-overlapping sampling pulses while a sufficient pulse width is assured for the sampling pulses in the first and second pulse trains so that the image signal is sampled appropriately.

According to another aspect of the present invention, there is provided a driving method for a display apparatus which includes a panel including a plurality of gate lines extending along rows, a plurality of signal lines extending along columns, a plurality of pixels arranged in a matrix at intersecting points at which the gate lines and the signal lines intersect with each other, and a plurality of image lines separated into two or more systems for supplying an image signal, a vertical driving circuit connected to the gate lines for successively selecting the rows of the pixels, a plurality of sampling switches disposed for connecting the signal lines to the image lines, and a horizontal driving circuit operable in response to a clock signal for successively generating sampling pulses to successively drive the sampling switches so that the image signal is successively written into the pixels of the selected row, comprising the steps of grouping the sampling switches into a first group wherein the sampling switches are disposed at intervals and a second group wherein the sampling switches are disposed in a relationship offset by a one-switch distance from the sampling switches which belong to the first group, connecting the image lines of a first one of the systems to the sampling switches of the first group and connecting the image lines of a second one of the systems to the sampling switches of the second group, distributing a train of the sampling pulses successively outputted from the horizontal driving circuit alternately to the sampling switches which belong to the first group and the sampling switches which belong to the second group to form a first pulse train and a second pulse train, respectively, and setting the sampling pulses in the first pulse train and the second pulse train such that adjacent ones of the sampling pulses in the first pulse train are non-overlapping sampling pulses and adjacent ones of the sampling pulses in the second pulse train are non-overlapping sampling pulses and securing a sufficient pulse width for the sampling pulses in the first and second pulse trains so that the image signal is sampled appropriately.

In the display apparatus and the driving method for a display apparatus, the horizontal driving circuit successively supplies sampling pulses to the sampling switches similarly as in a conventional display apparatus. On the other hand, the image lines are separated into two or more systems for supplying an image signal. In a corresponding relationship, the sampling switches are grouped into a first group and a second group such as an odd-number group and an even-number group. The image lines of a first one of the systems are connected to the odd-numbered sampling switches while the image lines of a second one of the systems are connected to the even-numbered sampling switches. As a result, although the sampling switches are successively driven by the common horizontal driving circuit, from the point of view of the sampling operation, they are grouped into two systems independent of each other, that is, into the odd-number system and the even-number system. Here, if attention is paid to the group of odd-numbered sampling switches, then after a sampling pulse is applied to the first sampling switch, another sampling pulse is applied to the third sampling switch. Further, every other sampling pulses are applied to the succeeding sampling switches similarly. Meanwhile, the second sampling pulse which is produced between the first sampling pulse and the third sampling pulse is distributed to the second sampling switch which belongs to the other system, that is, the even-numbered system, which operates independently of the odd-numbered system. Consequently, the second sampling pulse is sampled out and substantially abandoned with regard to the odd-numbered system. In this manner, where attention is paid to the odd-numbered group, adjacent ones of the sampling pulses automatically become non-overlapping sampling pulses by abandoning every other ones of the sampling pulses. Besides, since such a sufficiently long period of time as a period of time substantially equal to the pulse width can be set for the non-overlapping period of time, a ghost can be suppressed efficiently. Thus, according to the thinning out method described, since a non-overlapping time period can be assured automatically, the pulse width of the sampling pulse is not sacrificed, but the width can be assured to the maximum. Accordingly, also a vertical stripe can be suppressed. In this manner, with the display apparatus and the driving method for a display apparatus, both of the non-overlapping time period and the sampling pulse width can be assured, and both of improvement against a ghost and improvement against a vertical stripe can be anticipated.

In summary, with the display apparatus and the driving method for a display apparatus, an active matrix display apparatus of the dot-sequential type adopts a system wherein sampling switches are driven through different image lines independently of each other for sampling periods at odd-numbered stages and even-numbered stages. Where this system is employed, for example, also in the 6-phase XGA, a sampling pulse width and a non-overlapping time period between sampling pulses can be assured sufficiently, and therefore, both improvements against both of a vertical stripe and a ghost can be anticipated. Also in the 3-phase XGA, a sampling pulse width and a non-overlapping time period equivalent to those in the 6-phase XGA at present can be assured sufficiently, and a picture quality equivalent to that of the 6-phase XGA at present can be assured.

The above and other objects, features and advantages of the present invention will become apparent from the following description and the appended claims, taken in conjunction with the accompanying drawings in which like parts or elements denoted by like reference symbols.

### BRIEF DESCRIPTION OF THE DRAWINGS

These and other objects of the invention will be seen by reference to the description, taken in connection with the accompanying drawing, in which;

FIG. 1 is a block diagram showing a display apparatus to which the present invention is applied;

FIG. 2 is a circuit diagram showing a horizontal driving circuit included in the display apparatus of FIG. 1;

FIGS. 3 and 4 are timing charts illustrating operation of the horizontal driving circuit shown in FIG. 2;

FIG. 5 is a circuit diagram showing the display apparatus shown in FIGS. 1 and 2;

FIG. 6 is a circuit diagram showing a display apparatus as a comparative example;

FIGS. 7 and 8 are timing charts illustrating operation of the display apparatus of FIG. 6;

FIGS. 9A and 9B are a circuit diagram and a timing chart, respectively, illustrating a 12-dot simultaneous sampling driving method;

FIGS. 10A and 10B are a circuit diagram and a timing chart, respectively, illustrating a 6-dot simultaneous sampling driving method;

FIGS. 11A to 11C and FIGS. 12A to 12C are circuit diagrams and timing charts, respectively, illustrating non-overlapping driving adopted as the 6-dot simultaneous sampling driving method;

FIG. 13 is a view illustrating a ghost margin;

FIGS. 14A and 14B are a circuit diagram and a timing chart, respectively, illustrating a ghost margin;

FIG. 15 is a block diagram showing an example of a conventional display apparatus;

FIG. 16 is a circuit diagram showing a particular example of the display apparatus of FIG. 15; and

FIG. 17 is a timing chart illustrating operation of the circuit of FIG. 16.

### DETAILED DESCRIPTION OF THE PREFERRED EMBODIMENTS

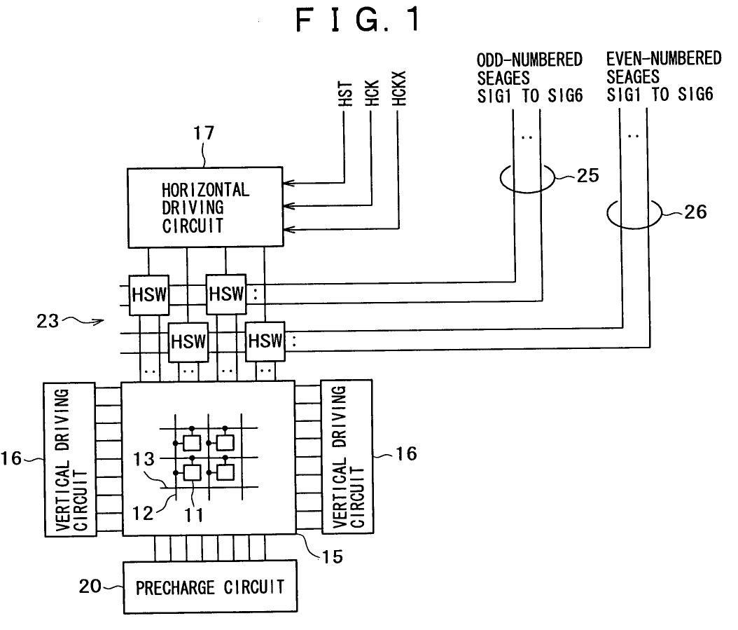

Referring to FIG. 1, there is shown a display apparatus to which the present invention is applied. The display apparatus shown basically includes a pixel array section 15, a vertical driving circuit 16, a horizontal driving circuit 17 and a sampling switch set 23. The display apparatus further includes a precharge circuit 20 and other circuits not shown as occasion demands. The components of the display apparatus are assembled in a single panel. The pixel array section 15 includes gate lines 13 extending along rows, signal lines 12 extending along columns and pixels 11 disposed in rows and columns at intersecting points of the gate lines 13 and the signal lines 12. The pixel array section 15 is disposed at a central portion of the panel. Further, image lines 25 and 26 for supplying an image signal are provided in at least two separate systems on the panel. The vertical driving circuit 16 is connected to the gate lines 13 to successively select the rows of the pixels 11. The sampling switch set 23 includes a plurality of sampling switches HSW and is disposed to connect the signal lines 12 of the columns to the image lines 25 and 26. The horizontal driving circuit 17 operates in response to clock signals HCK and HCKX to successively generate sampling pulses to be supplied to successively drive the sampling switches HSW so that an image signal is successively written into the pixels 11 of the selected row.

The sampling switches HSW of the sampling switch set 23 are grouped into a first group in which the sampling switches HSW are disposed sporadically and a second group in which the sampling switches HSW are disposed in a relationship offset by one sampling switch distance from the sampling switches HSW which belong to the first group. While the sampling switches HSW of the sampling switch set 23 are grouped only in the first and second groups, they may otherwise be grouped into three or more groups under certain circumstances. Where the sampling switches HSW of the sampling switch set 23 are grouped in two groups as in the present embodiment, odd-numbered ones of the sampling switches HSW belong to the first group (odd-number group) while even-numbered ones of the sampling switches HSW belong to the second group (even-number group). The image lines 25 of the first system are connected to the sampling switches HSW of the odd-number group while the image lines 26 of the second system are connected to the sampling switches HSW of the even-number group.

As a characteristic of the present invention, a train of sampling pulses successively outputted from the horizontal driving circuit 17 is distributed alternately to the sampling switches HSW belonging to the odd-number group and the sampling switches HSW belonging to the even-number group to form a first pulse train (odd-numbered pulse train) and a second pulse train (even-numbered pulse train), respectively. Since the sampling switches HSW in the first and second groups are distributed alternately, adjacent ones of the sampling pulses in the odd-numbered pulse train are placed into a non-overlapping relationship with each other while adjacent ones of the sampling pulses in the even-numbered pulse train are placed into a non-overlapping relationship with each other. Consequently, a ghost can be suppressed effectively. Further, since the non-overlapping relationships are established automatically, a sufficient pulse width can be assured for the individual sampling pulses, and consequently, a vertical stripe can be suppressed efficiently. As a result, both of a ghost and a vertical stripe can be suppressed, and appropriate sampling of an image signal can be achieved.

In the present embodiment, the first system is a bundle of six image lines 25, and the sampling switches HSW which belong to the odd-number group sample six image signals SIG1 to SIG6 supplied thereto from the six image lines 25 simultaneously into six signal lines 12. Also the second system is a bundle of six image lines 26, and the sampling switches HSW which belong to the even-number group sample six image signals SIG1 to SIG6 supplied thereto from the six image lines 26 simultaneously into different six signal lines 12. In the present embodiment, an image signal of the XGA standards is written into the pixels 11 disposed in rows and columns through totaling 12 image lines. However, the present invention is not limited to the specific arrangement. Preferably, the first system is a bundle of at least three image lines, and the sampling switches which belong to the first group sample three image signals supplied thereto from the three image lines simultaneously into three signal lines. Also the second system is a bundle of at least three image lines, and the sampling switches which belong to the second group sample three image signals supplied thereto from the three image lines simultaneously into different three signal lines.

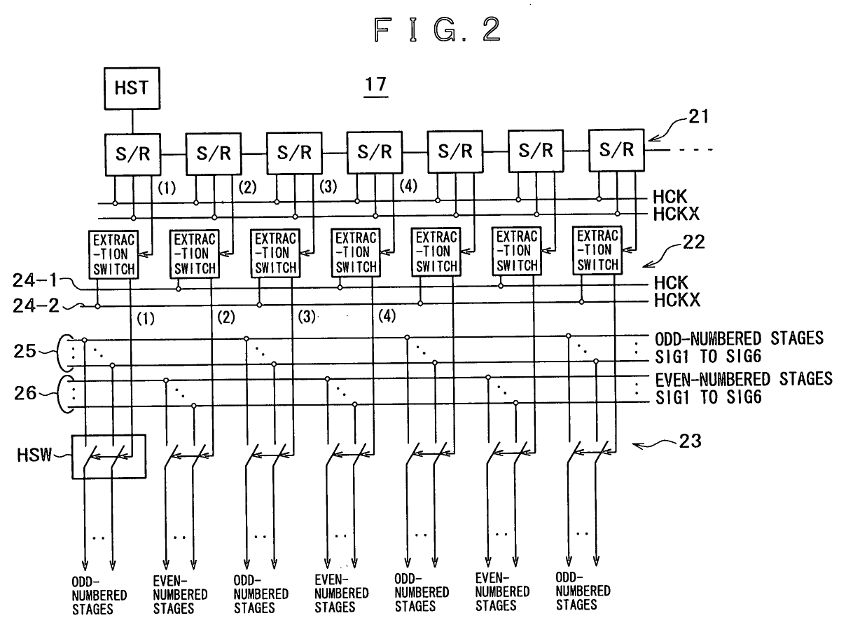

FIG. 2 shows a form of the horizontal driving circuit included in the display apparatus shown in FIG. 1. Referring to FIG. 2, the horizontal driving circuit 17 includes a shift register 21 and an extracting switch set 22. The shift register 21 performs a shifting operation of a horizontal start pulse HST in synchronism with clock signals HCK and HCKX and successively outputs shift pulses (transfer pulses) (1), (2), (3) and (4) from the individual shift stages (R/S). The extracting switch set 22 extracts a clock signal same as the clock signals HCK and HCKX in response to the shift pulses successively outputted from the shift register 21 to successively produce sampling pulses (1), (2), (3) and (4). It is to be noted that the clock signals HCK and HCKX extracted by the extracting switch set 22 are supplied through wiring lines 24-1 and 24-2 separately from the clock signals HCK and HCKX supplied to the shift register 21. The sampling pulse (1) is applied to the sampling switches HSW at an odd-numbered stage, and the next sampling pulse (2) is supplied to the sampling switches HSW at an even-numbered state. Further, the next sampling pulse (3) is applied to the sampling switches HSW at another odd-numbered stage, and the sampling pulse (4) is applied to the sampling switches HSW at another even-numbered stage. In this manner, the sampling pulses successively outputted from the horizontal driving circuit 17 are distributed alternately to the sampling switches HSW at the odd-numbered stages and the sampling switches HSW at the even numbered stages.

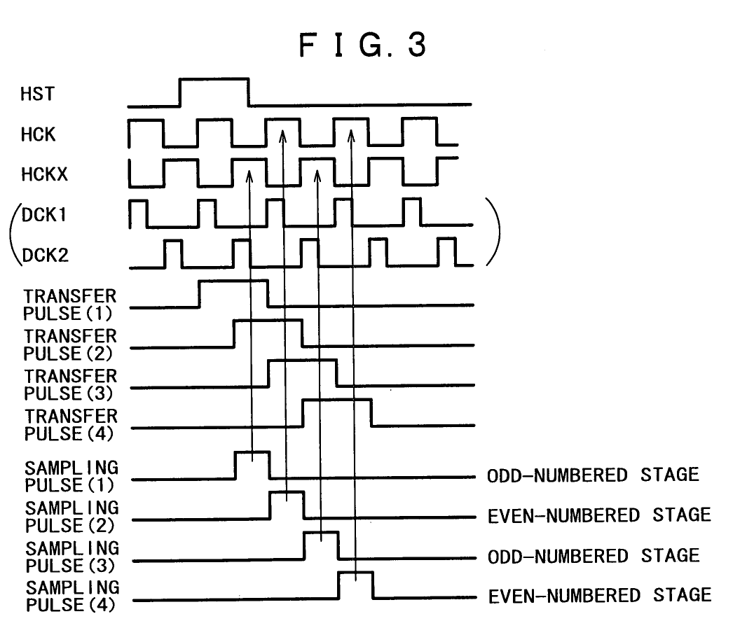

FIG. 3 is a timing chart illustrating operation of the horizontal driving circuit shown in FIG. 2. The shift register operates in response to the HCK pulse and the HCKX pulse to successively transfer the horizontal start pulse HST and outputs transfer pulses (1), (2), (3) and (4). As seen in FIG. 3, the transfer pulses are successively shifted by an amount equal to one half the period of the HCK pulse. Then, the extracting switch set 22 operates to open and close in response to the transfer pulses to extract the HCK pulses or the HCKX pulses to successively produce sampling pulses (1), (2), (3) and (4). For example, the extracting switch at the first stage extracts the HCKX pulse in response to the transfer pulse (1) to produce the sampling pulse (1). The sampling pulse (1) thus produced is sent to the sampling switches HSW at an odd-numbered stage. The extracting switch at the second stage operates to open and close in response to the transfer pulse (2) to extract the HCK pulse to produce the sampling pulse (2). The sampling pulse (2) thus produced is sent to the sampling switches HSW at an even-numbered stage. The extracting switch at the third stage operates to open and close in response to the transfer pulse (3) to extract the HCKX pulse to produce the sampling pulse (3). The extracting switch at the fourth stage operates to open and close in response to the transfer pulse (4) to extract the HCK pulse to produce the sampling pulse (4).

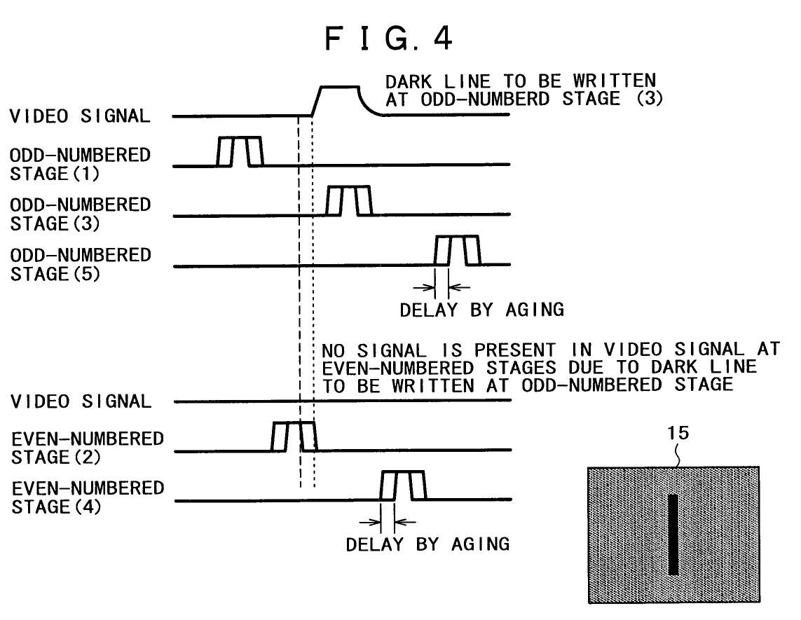

As can be seen apparently from the timing chart of FIG. 4, between the sampling pulses (1) and (3) which belong to the same system, the sampling pulse (2) which belongs to the different system is interposed. Similarly, between the sampling pulses (2) and (4), the sampling pulse (3) which belongs to the different system is interposed. Where attention is paid to one of the systems, a non-overlapping period of time equal to one half the cycle of the HCK pulse is interposed between adjacent ones of pulses of the sampling pulse train. Where an image signal of the XGA standards has a six-phase configuration of SIG1 to SIG6 as in the present embodiment, one half period of the HCK pulse is approximately 80 to 90 nsec. This time width is sufficient as the non-overlapping time period and can suppress a ghost efficiently. Further, in the present embodiment, since the extracting switch set 22 extracts the HCK pulse or the HCKX pulse, also the width of the sampling pulse is approximately 80 to 90 nsec equal to the non-overlapping time period. Since the sampling pulse is not a small pulse of approximately 30 to 45 nsec, it can suppress appearance of a vertical stripe effectively.

In the present embodiment, since the sampling pulses are distributed alternately between the odd-numbered stages and the even-numbered stages, a sufficient non-overlapping period of time can be assured. Accordingly, such clock signals DCK1 and DCK2 of a small pulse width as in the conventional art need not be used, but the clock signals HCK and HCKX can be extracted to produce the sampling pulses. Since the DCK pulses are not required, the circuit layout can be made compact accordingly. Further, also where a video signal of the XGA standards is written not in six phases but in three phases, approximately 30 to 45 nsec can be assured for both of the sampling time and the non-overlapping time. Accordingly, a picture quality available at present can be obtained also where the 3-phase XGA is employed.

FIG. 4 is a timing chart schematically illustrating operation of the present embodiment. Where a dark line is written into the pixel (3) at an odd-numbered stage, the image signal (video signal) has such a waveform as seen in FIG. 4. A sampling pulse at the odd-numbered stage (3) is generated corresponding to a peak portion of the video signal. The sampling pulse signal has a phase which varies with respect to time, and suffers from a delay by aging as seen in FIG. 4. As a result, the sampling time is displaced with respect to the video signal. However, unless the delay is not extreme, the sampling pulse can sample a peak of the video signal. Consequently, a dark line is displayed on the pixel column corresponding to the odd-numbered stage (3) of the pixel array section 15.

On the other hand, since the video signal supplied to an even-numbered stage does not write a dark line, it does not include a peak and therefore has a flattened waveform corresponding to the background color. The flat video signal is successively sampled with the sampling pulses at the even-numbered stages (2) and (4). Although the sampling pulse at the even-numbered state (2) varies due to a delay by aging, since the video signal does not include a peak corresponding to a dark line at all, no ghost appears. If independent image lines are not provided otherwise for the odd-numbered stages and the even-numbered stages, then since the sampling pulse at the even-numbered stage (2) samples a peak of the video signal to be written at the odd-numbered stage (3) in error, a front ghost appears.

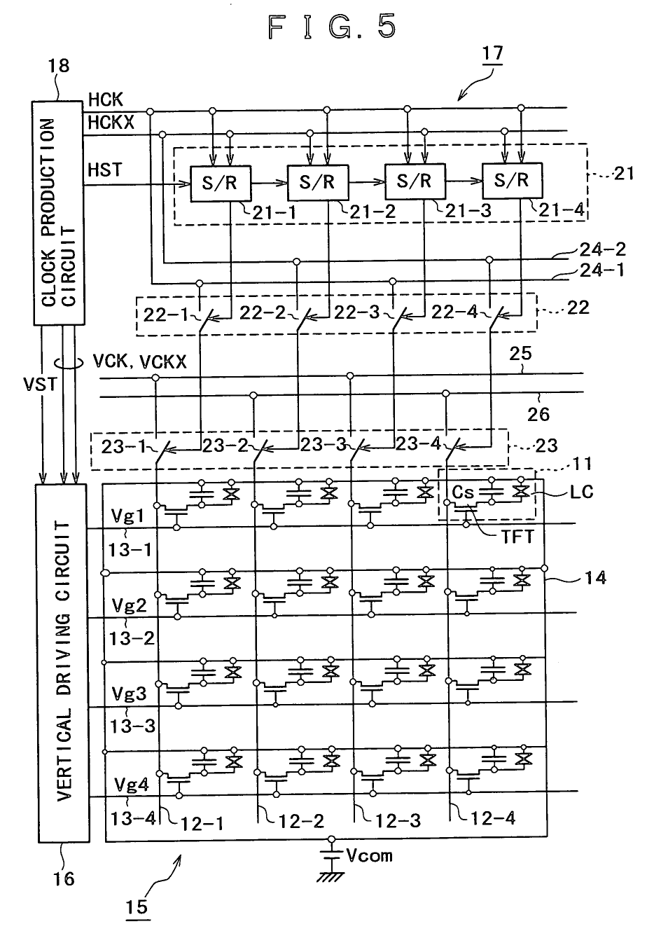

FIG. 5 is a circuit diagram showing an example of a detailed configuration of the display apparatus shown in FIGS. 1 and 2. Referring to FIG. 5, the display apparatus shown uses a liquid crystal cell as a display element (electro-optical element) of each pixel. In FIG. 5, an arrangement of pixels in four rows and four columns is shown as an example for simplified illustration and description. Each of the pixels 11 arranged in a matrix of four rows and four columns includes a thin film transistor TFT which is a pixel transistor, a liquid crystal cell LC having a pixel electrode connected to the drain electrode of the thin film transistor TFT, and a retaining capacity Cs having one of electrodes connected to the drain electrode of the thin film transistor TFT. The signal lines 12-1 to 12-4 are wired to extend along the direction of arrangement of the pixels 11 for each column, and gate lines 13-1 to 13-4 are disposed to extend along the direction of arrangement of the pixels 11 for each row.

In each of the pixels 11, the source electrode (or the drain electrode) of the thin film transistor TFT is connected to a corresponding one of the signal lines 12-1 to 12-4. The gate electrode of the thin film transistor TFT is connected a corresponding one of the gate lines 13-1 to 13-4. the opposing electrode of the liquid crystal cell LC and the other electrode of the retaining capacity Cs are connected to a Cs line 14 commonly to the pixels. A predetermined dc voltage is applied as a common voltage Vcom to the Cs line 14.

Consequently, a pixel array section 15 is configured such that the pixels 11 are arranged in a matrix and the signal lines 12-1 to 12-4 are wired for the individual columns and the gate lines 13-1 to 13-4 are wired for the individual rows to the pixels 11. In the pixel array section 15, one end of each of the gate lines 13-1 to 13-4 is connected to an output terminal at a corresponding one of the stages of the vertical driving circuit 16 disposed, for example, on the left side of the pixel array section 15.

The vertical driving circuit 16 scans in the vertical direction (in the direction of a column) for each one field period to successively select the pixels 11 connected to the gate lines 13-1 to 13-4 in a unit of a row. In particular, when a scanning pulse Vg1 is applied from the vertical driving circuit 16 to the gate line 13-1, the pixels on the first row are selected, but when another scanning pulse Vg2 is applied to the gate line 13-2, the pixels on the second row are selected. Further, scanning pulses Vg3 and Vg4 are successively applied to the gate lines 13-3 and 13-4 in a similar manner, respectively.

A horizontal driving circuit 17 is disposed, for example, on the upper side of the pixel array section 15 in FIG. 5. Further, a clock production circuit (timing generator) 18 for supplying various clock signals to the vertical driving circuit 16 and the horizontal driving circuit 17 is provided. The external clock production circuit 18 produces a vertical start pulse VST for indicating starting of vertical scanning, vertical clocks VCK and VCKX having phases opposite to each other and serving as a reference to vertical scanning, a horizontal start pulse HST for indicating starting of horizontal scanning, and horizontal clocks HCK and HCKX having phases opposite to each other and serving as a reference to horizontal scanning.

The horizontal driving circuit 17 successively samples an image signal inputted from image lines 25 and 26 of two different systems for each 1 H (H is a horizontal scanning period) to perform a process of writing into the pixels 11 selected in a unit of a row by the vertical driving circuit 16. In the present example, the horizontal driving circuit 17 adopts a clock drive method and includes a shift register 21, a clock extracting switch set 22, and a sampling switch set 23. The shift register 21 has four shift stages (S/R) 21-1 to 21-4 corresponding to the number of columns of pixels (in the present example, fourth columns) of the pixel array section 15 and performs a shifting operation in synchronism with the horizontal clocks HCK and HCKX of the phases opposite to each other after the horizontal start pulse HST is applied thereto. Consequently, the shift stages 21-1 to 21-4 successively output shift pulses having a pulse width equal to the period of the horizontal clocks HCK and HCKX.

The clock extracting switch set 22 includes four switches 22-1 to 22-4 corresponding to the pixel columns of the pixel array section 15 and having ends connected alternately to clock lines 24-1 and 24-2 which transmit the horizontal clocks HCK and HCKX, respectively. More particularly, one end of each of the switches 22-1 and 22-3 is connected to the clock line 24-1 while one end of each of the switches 22-2 and 22-4 is connected to the clock line 24-2.

Applied to the switches 22-1 to 22-4 of the clock extracting switch set 22 are the shift pulses successively outputted from the shift stages 21-1 to 21-4 of the shift register 21, respectively. When the shift pulses are applied to the switches 22-1 to 22-4 from the shift stages 21-1 to 21-4 of the shift register 21, the switches 22-1 to 22-4 are successively placed into an on state in response to the shift pulses, respectively, thereby to alternately extract the horizontal clocks HCK and HCKX of the phases opposite to each other.

The sampling switch set 23 includes fourth switches 23-1 to 23-4 corresponding to the pixel columns of the pixel array section 15, and ends of the switches 23-1 to 23-4 on one side are alternately connected to the image lines 25 for inputting an image signal of one of the systems and the image lines 26 for inputting an image signal of the other system. To the switches 23-1 to 23-4 of the sampling switch set 23, the horizontal clocks HCK and HCKX extracted by the switches 22-1 to 22-4 of the clock extracting switch set 22 are applied as sampling pulses, respectively.

When the sampling pulses are applied from the switches 22-1 to 22-4 of the clock extracting switch set 22 to the switches 23-1 to 23-4 of the sampling switch set 23, respectively, the switches 23-1 to 23-4 are successively placed into an on state in response to the sampling pulses thereby to successively and alternately sample the image signal of the two systems inputted through the image lines 25 and 26 so as to be supplied to the signal lines 12-1 to 12-4 of the pixel array section 15. Further, the sampled image signal is written into the liquid crystal cell LC of any of the pixels 11 through the thin film transistor TFT selectively turned on.

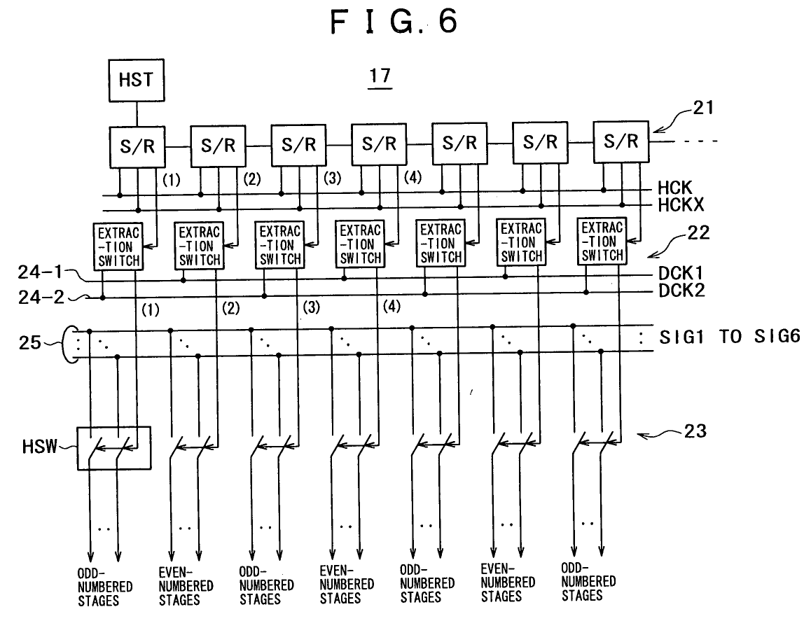

FIG. 6 shows a display apparatus as a comparative example. In FIG. 6, in order to facilitate understanding, like elements to those of FIG. 2 are denoted by like reference characters. In the display apparatus of the embodiment shown in FIG. 2, six-phase image signals are written separately in two systems. In contrast, in the comparative example shown in FIG. 6, six-phase image signals are written only in one system. In other words, the six-phase image signals SIG1 to SIG6 are supplied by image lines 25 of one system, and the sampling switches HSW of the sampling switch set 23 are all connected commonly to the image lines 25 irrespective of whether each of them is at an odd-numbered stage or an even-numbered stage. Further, to the clock lines 24-1 and 24-2, not the horizontal clocks HCK and HCKX but narrow pulses DCK1 and DCK2 are supplied.

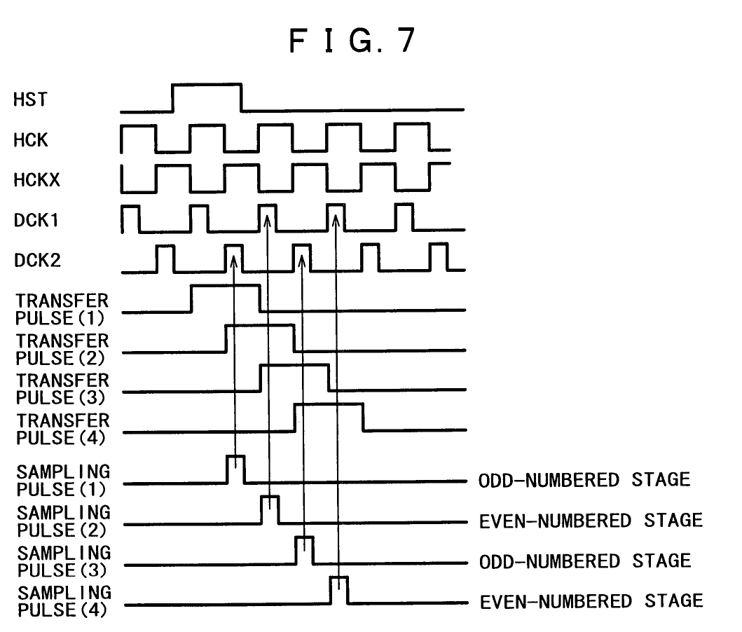

FIG. 7 is a timing chart illustrating operation of the display apparatus of the comparative example shown in FIG. 6. In FIG. 7, in order to facilitate understanding, like portions to those of the timing chart shown in FIG. 3 are denoted by like reference characters. As seen from FIG. 7, the shift register operates in response to the horizontal clocks HCK and HCKX to successively transfer the horizontal start pulse HST to produce transfer pulses (1), (2), (3) and (4). The extracting switch set operates in response to the transfer pulses (1), (2), (3) and (4) to extract the pulses DCK1 and DCK2 supplied thereto separately from the horizontal clocks HCK and HCKX to produce sampling pulses (1), (2), (3) and (4). Since the narrow pulses DCK1 and DCK2 are pulses narrower than those of the horizontal clocks HCK and HCKX, also the sampling pulses (1), (2), (3) and (4) have a smaller width. Further, since the sampling pulses (1), (2), (3) and (4) are successively formed at any of the odd-numbered stages and the even-numbered stages, also the overlapping time period is shorter. It is to be noted that the overlapping time period is produced by extracting the narrower pulses DCK1 and DCK2. The non-overlapping time period is limited because it is restricted significantly different from the non-overlapping time period produced by the sampling out method as in the present invention.

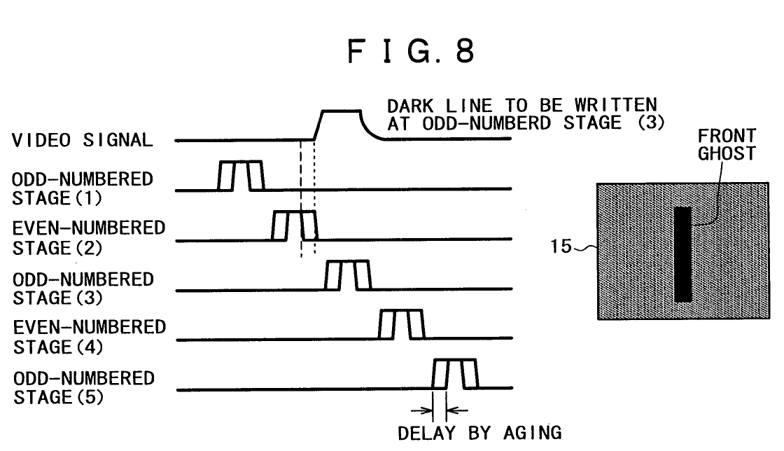

FIG. 8 illustrates writing of a dark line into the pixel column of the odd-numbered stage (3) in the comparative example illustrated in FIG. 7. The video signal includes a peak in order to write a dark line. A sampling pulse corresponding to the odd-numbered stage (3) samples the peak included in the video signal to write a dark line into the pixel array section 15. At this time, if a sampling pulse corresponding to the even-numbered stage (2) which is an immediately preceding stage suffers from a delay by aging, then there is the possibility that it may correspond to the peak of the video signal to sample the dark level. At this time, a ghost appears at the pixel column of the even-numbered stage (2) preceding to the dark line written in the pixel column of the odd-numbered state (3).

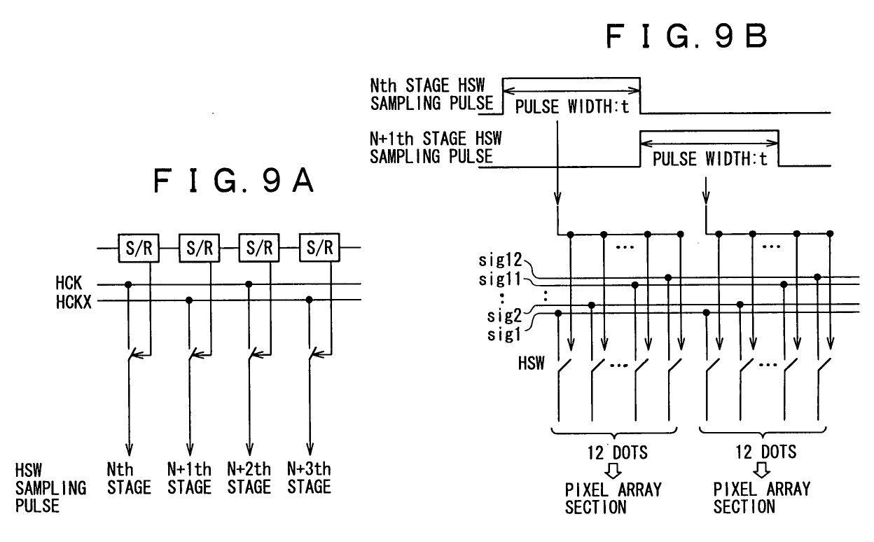

In the following, more detailed description is given with regard to a case wherein an image signal of the XGA standards is displayed on a display apparatus of the active matrix type. FIGS. 9A and 9B schematically illustrate a conventional system called 12-dot simultaneous sampling system. As seen from FIG. 9A, the horizontal clocks HCK and HCKX are extracted with transfer pulses successively outputted from individual stages (S/R) of a shift register to produce sampling pulses for sampling switches HSW. The sampling pulses are successively applied to the sampling switches HSW of the Nth, N+1th, N+2th and N+3th stages.

FIG. 9B illustrates a sampling pulse applied to the Nth stage sampling switch HSW and another sampling pulse applied to the N+1th stage sampling switch HSW. The sampling pulses have an equal pulse width t. An image signal of the XGA standards is supplied separately in 12 different phases (SIG1 to SIG12) from the outside through image lines. Conventionally, the 12-phase image signal is sent along image lines of one system. Accordingly, the 12-phase image signal is sampled to a set of 12 signal lines through respective sampling switches HSW. When a sampling pulse having the pulse width t is applied to the sampling switch HSW at the Nth stage, the signals SIG1 to SIG12 are sampled at a time and written into 12 pixels (dots) at a time. Accordingly, the system is called 12-dot simultaneous sampling. The XGA standards involve a greater number of pixels than the SVGA standards. The number of simultaneously written dots is increased as much to reduce the sampling frequency thereby to secure the sampling pulse width. In the conventional XGA 12-dot simultaneous sampling driving, even where the non-overlapping system is adopted, approximately 150 nsec can be assured for the sampling pulse width t. Therefore, even if the HSW sampling pulse width at an adjacent stage is displaced by an amount approximately equal to an actual capacity value of a polycrystalline silicon TFT (for example, displaced by approximately 2 nsec), the displacement does not appear as a great difference in the sampling hold potential, and a vertical stripe (sampling period hoop) corresponding to the sampling period does not appear on the screen. Further, due to improvement in uniformity, also the margin of a precharge signal supplied from the precharge circuit is as high as approximately 1.0 V with respect to a vertical stripe, and therefore, there is no problem.

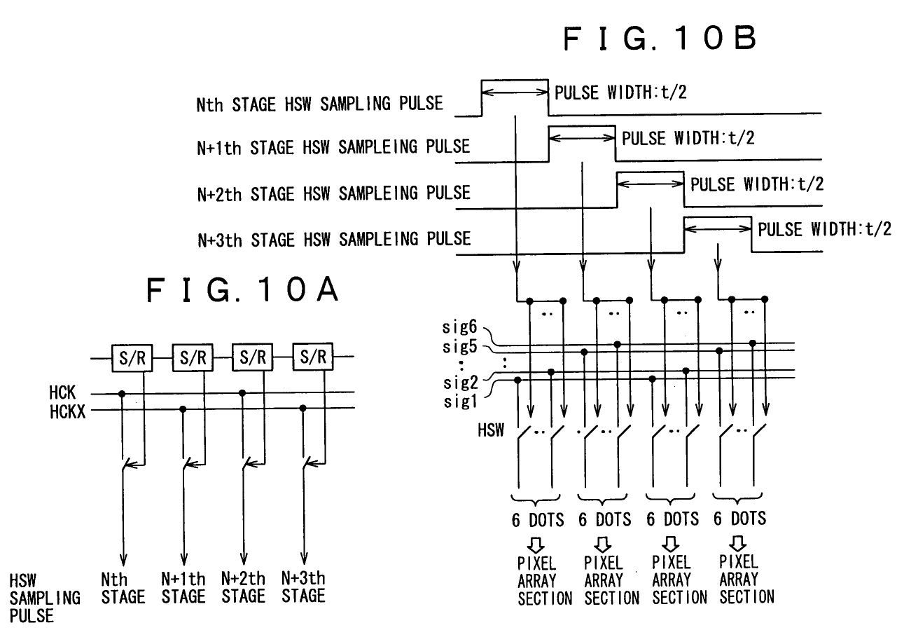

As the number of types of liquid crystal display panels (LCD panels) increases, common use of a driving IC for both of the SVGA and XGA standards is proceeding. Thus, development of a technique for driving an XGA panel, which has conventionally been driven by the 12-dot simultaneous sampling system, by the 6-dot simultaneous sampling system same as that in the SVGA standards is proceeding. Consequently, although the 12-dot simultaneous sampling system requires two sample hold ICs for an image signal for each of panels for R, G and B, the 6-dot simultaneous sampling method decreases the number of required sample hold ICs to one half, that is, to one for each of panels for R, G and B, which reduces the cost. FIGS. 10A and 10B schematically illustrate the 6-dot simultaneous sampling system for an XGA panel. In FIGS. 10A and 10B, in order to facilitate understanding, like portions to those of the schematic views of the 12-dot simultaneous sampling system shown in FIGS. 9A and 9B are denoted by like reference characters. FIG. 10A schematically shows a sampling circuit and FIG. 10B is a timing chart of 6-dot simultaneous sampling. As apparently seen from contrast of the 6-dot simultaneous sampling of FIGS. 10A and 10B with the 12-dot simultaneous sampling of FIGS. 9A and 9B, the sampling pulses of the 6-dot simultaneous sampling driving have a pulse width equal to one half that of the 12-dot simultaneous sampling driving. Further, if the non-overlapping sampling driving is adopted as a countermeasure against a vertical stripe or in order to increase the ghost margin, then it is necessary to further reduce the sampling pulse width. Actually, the sampling pulse width becomes as narrow as approximately 30 to 45 nsec.

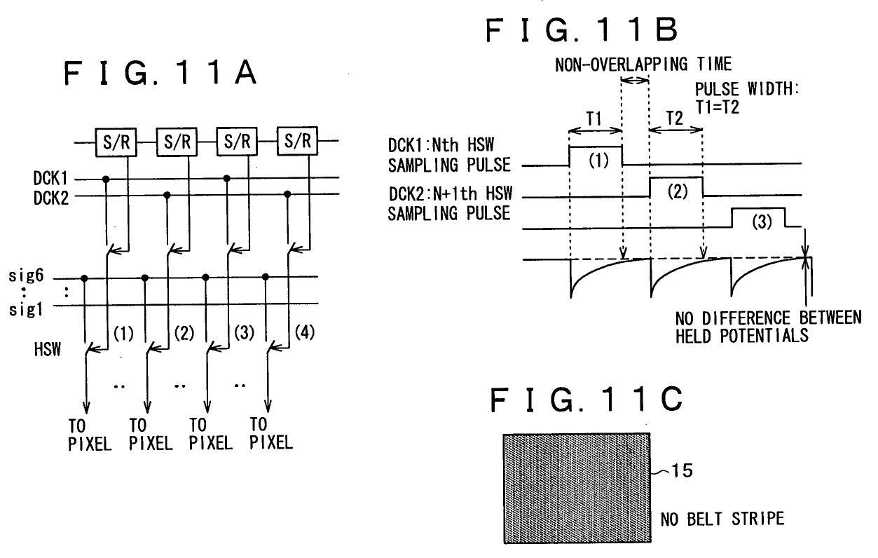

FIGS. 11A to 11C schematically show a circuit which adopts the non-overlapping driving of the 6-dot simultaneous sampling method and operation of the circuit, respectively. In FIGS. 11A to 11C, in order to facilitate understanding, like portions to those of the 6-dot simultaneous sampling system shown in FIGS. 10A and 10B where the non-overlapping method are not adopted are denoted by like reference characters. As seen in FIG. 11A, in the non-overlapping driving, the narrow pulses DCK1 and DCK2 are extracted with transfer pulses successively outputted from the stages (S/R) of the shift register to produce sampling pulses (1), (2), (3) and (4). The sampling switches HSW operate to open and close in response to a sampling pulse to simultaneously sample six-phase image signals sig1 to sig6 and write them into corresponding pixels.

FIG. 11B is a timing chart illustrating the sampling pulses (1), (2) and (3). The sampling pulse (1) is produced by extracting the narrow pulse DCK1 and has a pulse width T1. The sampling pulse (2) is produced by extracting the narrow pulse DCK2 and has a pulse width T2. The narrow pulses DCK1 and DCK2 have a basically equal pulse width although the phases thereof are displaced by 180 degrees from each other. Accordingly, the pulse widths T1 and T2 of the sampling pulses (1) and (2) have a relationship of T1=T2. It is to be noted that a predetermined non-overlapping period of time is interposed between the sampling pulses (1) and (2). In the state illustrated in FIG. 11B, since T1=T2, no potential difference appears between the held potentials of the image signal. Accordingly, a vertical stripe (sampling period hoop) does not appear on the pixel array section 15 shown in FIG. 11C.

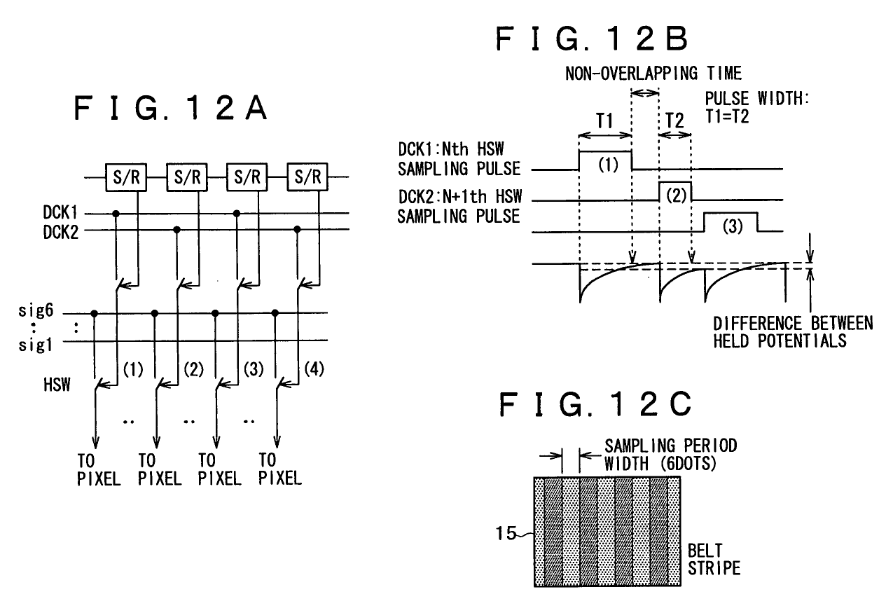

FIGS. 12A to 12C illustrate appearance of a displacement in duty ratio between the narrow pulses DCK1 and DCK2. In FIGS. 12A to 12C, in order to facilitate understanding, like portions to those shown in FIGS. 11A to 11C where there is no displacement in duty ratio are denoted by like reference characters. If a displacement in duty ratio is present between the narrow pulses DCK1 and DCK2 as seen in FIG. 12B, then an error appears between the pulse width T1 of the sampling pulse (1) and the pulse width T2 of the sampling pulse (2). Consequently, a difference appears between the potentials (held potentials) of the video signal sample held with the sampling pulses (1) and (2). As a result, hoops appear with a width of the sampling period on the pixel array section 15 as seen in FIG. 12C. As described hereinabove, if a non-overlapping period of time is taken in the 6-dot simultaneous driving system, then the sampling pulse becomes a narrow pulse of approximately 30 to 45 nsec. Since the pulse width is small, a displacement in duty by approximately 2 nsec conspicuously appears as a displacement in held potential remarkably. Therefore, the margin of the precharge signal decreases to approximately 0.2 V, and consequently, sampling period hoops are liable to occur.

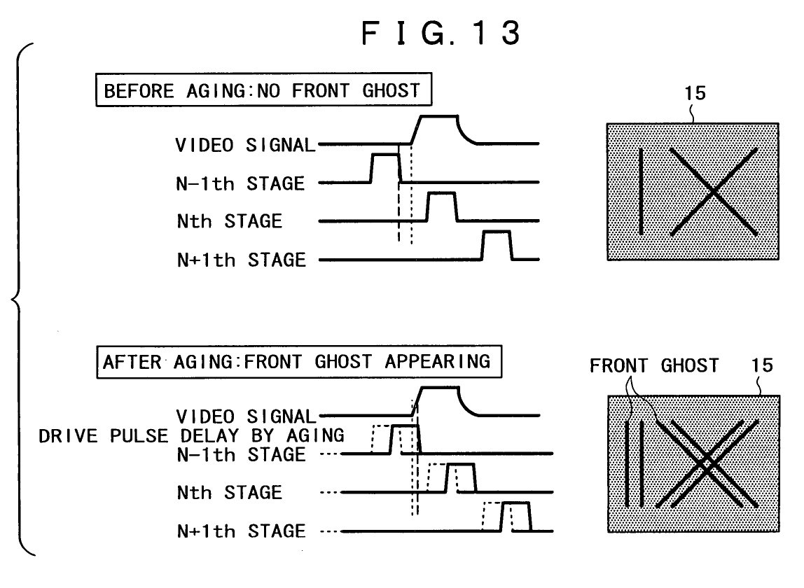

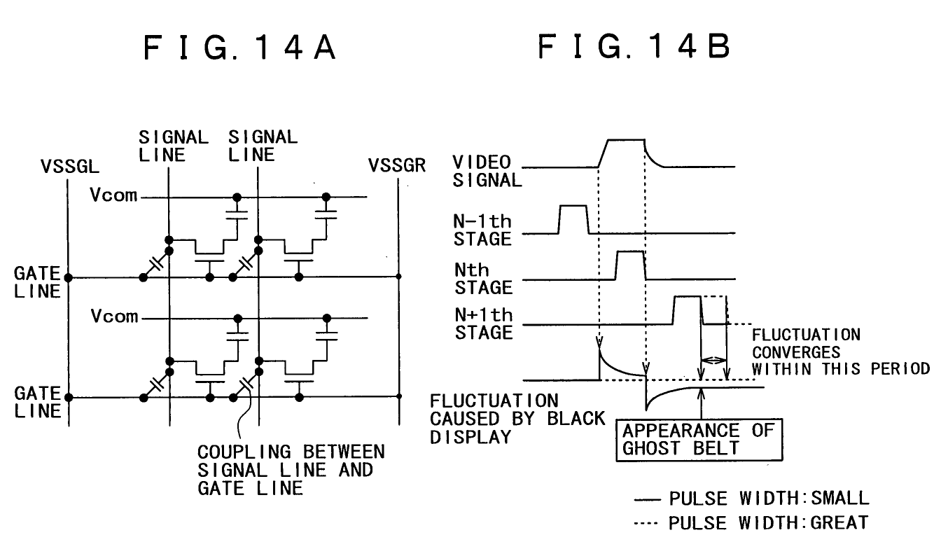

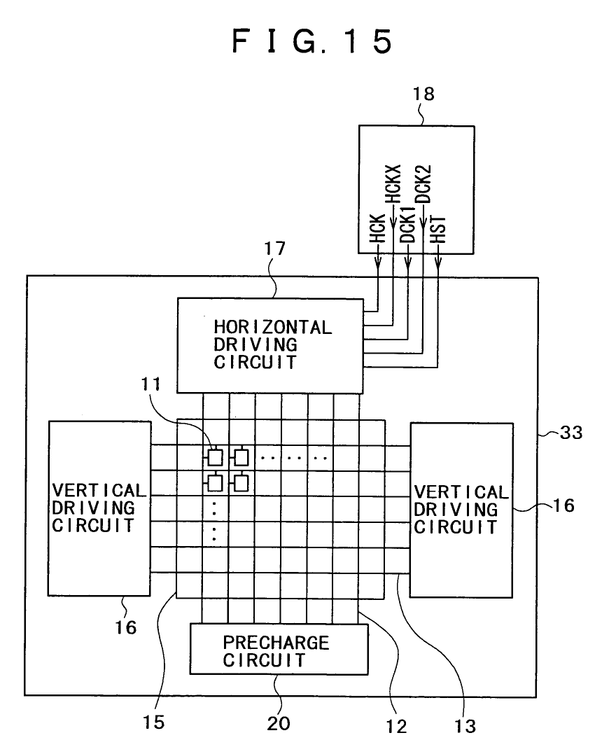

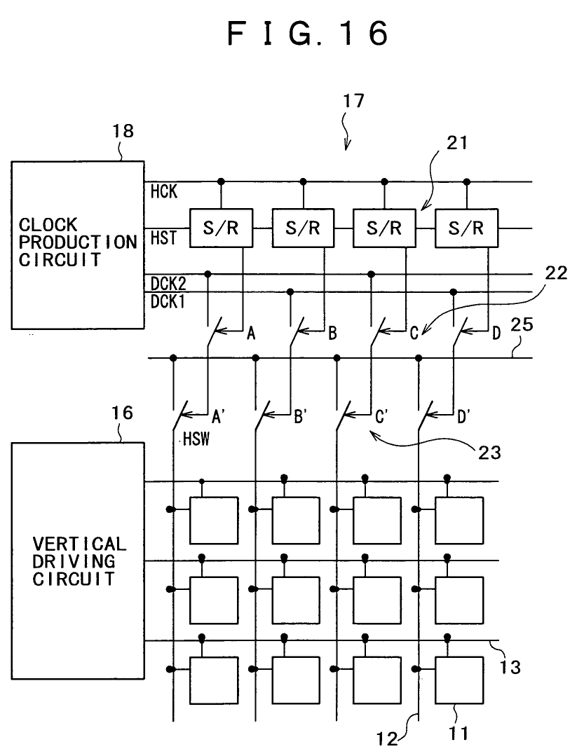

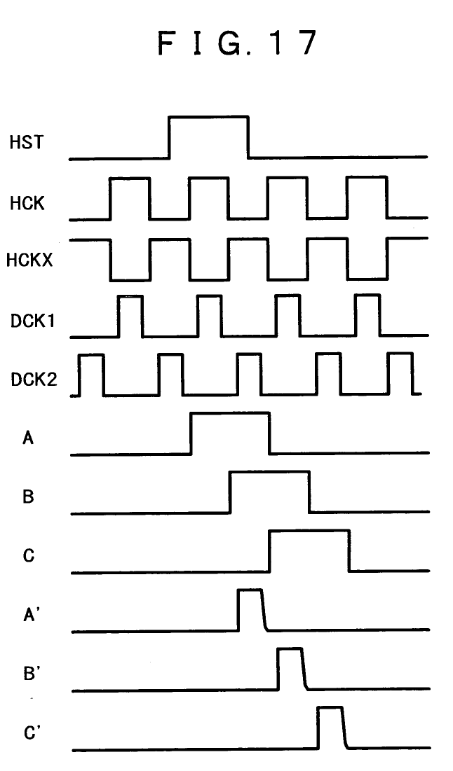

Description of a ghost is continued. FIGS. 13A and 13B schematically illustrate a cause of appearance of a ghost. More particularly, FIGS. 13A and 13B schematically illustrate a cause of appearance of a ghost when a peak of the dark level included in a video signal is written into a pixel column of the Nth stage. At an initial state (prior to aging), no delay of a sampling pulse occurs, and therefore, the dark level of the video signal can be sampled accurately with a sampling pulse of the Nth stage. Accordingly, no front ghost appears. In contrast, after aging, a delay occurs with a sampling pulse (drive pulse), and therefore, under certain circumstances, the peak of the dark level of the video signal is sometimes sampled partially with a drive pulse at the preceding stage (N-1th stage). In this instance, a front ghost appears. This aging effect is caused, for example, by a Vth shift by a hot carrier of a TFT. The delay width of a drive pulse by the aging effect is approximately 30 nsec. If the period of time of a delay amount permitted for a drive pulse after the initialization in which a state in which no ghost appears is established till a point of time before another state wherein a ghost appears due to a delay of a sampling pulse (drive pulse) is reached is defined as a ghost margin, then the margin to a front ghost is approximately 30 nsec. In the conventional XGA 12-dot simultaneous sampling driving, even if the non-overlapping time period is set to 30 nsec or more which is a period of time corresponding to a pulse variation by aging, approximately 150 nsec can be assured for the sampling pulse width. However, in the 6-dot simultaneous driving, if the non-overlapping time period is set to approximately 30 nsec or more which exceeds the ghost margin, then only approximately 30 to 45 nsec corresponding to a narrow pulse can be assured for the sampling pulse width. The pulse width of approximately 30 to 45 nsec is a region within which sampling period hoops are liable to occur as described hereinabove.

Where a ghost margin is examined, also it is necessary to take a ghost belt into consideration in addition to the front ghost described hereinabove with reference to FIGS. 13A and 13B. A cause of appearance of a ghost belt is schematically illustrated in FIGS. 14A and 14B. FIG. 14A illustrates a capacitive coupling between a signal line and a gate line, and FIG. 14B schematically illustrates a cause of appearance of a ghost belt by the coupling. A ghost belt appears because a fluctuation caused by, for example, a black window display is passed to a gate line and then passed to a signal line at a neighboring stage and then the signal potential varied by the fluctuation is held. If a sampling pulse is delayed, then since the period of time between the fluctuation of the video signal and the holding time becomes narrow, a ghost belt appears. If the sampling pulse width is great, then since the video signal is held after the fluctuation is settled, appearance of a ghost belt is delayed. On the contrary, if the sampling pulse width is small, since the video signal is held before the fluctuation is settled, appearance of a ghost belt is advanced. In a region wherein the sampling pulse width is as small as approximately 30 to 45 nsec, a ghost margin becomes a ghost belt rate determination illustrated in FIG. 14 rather than a front ghost described above and is influenced by the pulse width rather than by the non-overlapping time period. Accordingly, even if the non-overlapping time period is increased, the ghost margin does not increase.

Usually, if an LCD panel is continuously driven for a long period of time, then a Vth shift by a hot carrier of a TFT occurs and a pulse driven by the TFT is delayed. In contrast, no delay occurs with a video signal because the video signal does not pass through the TFT. Therefore, a front ghost appears as described hereinabove. The variation amount of the Vth shift by a hot carrier of a TFT is approximately 30 nsec, and conventionally, the 12-phase XGA assures a sufficient ghost margin by setting the non-overlapping time periods between a preceding stage and a pertaining stage and between the pertaining stage and a succeeding stage to approximately 30 nsec. In contrast, where the non-overlapping time period is set to approximately 30 nsec similarly in the 6-phase XGA, the HSW sampling pulse becomes a narrow pulse of approximately 30 to 45 nsec and sampling period hoops are liable to occur. Further, since the HSW sampling pulse is a narrow pulse, a ghost belt becomes dominant in a ghost margin, and even if the non-overlapping time period is increased, the ghost margin does not increase beyond a fixed amount. In other words, if the non-overlapping time period is increased, then the pulse width must be decreased as much, and this makes a ghost belt liable to appear. Accordingly, even if the non-overlapping time period is increased, the ghost margin does not increase beyond a fixed level. Therefore, a novel circuit configuration is required which provides a sufficient HSW sampling pulse width with which no period hoop appears even in the 6-phase XGA driving and besides does not cause a ghost to appear even if an HSW sampling pulse is delayed by approximately 30 nsec. Taking this into consideration, the present invention proposes such a novel circuit configuration as described hereinabove with reference to FIGS. 1 and 2.

While a preferred embodiments of the present invention has been described using specific terms, such description is for illustrative purposes only, and it is to be understood that changes and variations may be made without departing from the spirit or scope of the following claims.

What is claimed is:

1. A display apparatus, comprising:
a panel including a plurality of gate lines extending along rows, a plurality of signal lines extending along columns, a plurality of pixels arranged in a matrix at intersecting points at which said gate lines and said signal lines intersect with each other, and a plurality of image lines separated into two or more systems for supplying an image signal;
a vertical driving circuit connected to said gate lines for successively selecting the rows of said pixels;
a plurality of sampling switches disposed for connecting said signal lines to said image lines; and
a horizontal driving circuit operable in response to a clock signal for successively generating sampling pulses to successively drive said sampling switches so that the image signal is successively written into the pixels of the selected row;
said sampling switches being grouped into a first group wherein the sampling switches are disposed at intervals and a second group wherein the sampling switches are disposed in a relationship offset by a one-switch distance from the sampling switches which belong to said first group;
the image lines of a first one of the systems being connected to the sampling switches of the first group while the image lines of a second one of the systems being connected to the sampling switches of the second group;
a train of the sampling pulses successively outputted from said horizontal driving circuit being distributed alternately to the sampling switches which belong to the first group and the sampling switches which belong to the second group to form a first pulse train and a second pulse train, respectively;
the sampling pulses in the first pulse train and the second pulse train being set such that adjacent ones of the sampling pulses in the first pulse train are non-overlapping sampling pulses and adjacent ones of the sampling pulses in the second pulse train are non-overlapping sampling pulses while a sufficient pulse width is assured for the sampling pulses in the first and second pulse trains so that the image signal is sampled appropriately.

2. A display apparatus according to claim 1, wherein said horizontal driving circuit includes a shift register for performing a shifting operation in synchronism with the clock signal to successively output shift pulses from individual shift stages thereof, and a set of extracting switches for extracting a clock signal same as the clock signal in response to the shift pulses successively outputted from said shift register to successively produce the sampling pulses.

3. A display apparatus according to claim 1, wherein the first system includes a bundle of at least three image lines and the sampling switches which belong to the first group sample three image signals supplied from the three image lines at a time to three ones of said signal lines, and the second system includes a bundle of at least three image lines and the sampling switches which belong to the second group sample three image signals supplied from the three image lines at a time into different three signal lines.

4. A display apparatus according to claim 3, wherein the first system includes a bundle of six image lines and the sampling switches which belong to the first group sample six image signals supplied from the six image lines at a time to six ones of said signal lines and the second system includes a bundle of six image lines and the sampling switches which belong to the second group sample six image signals supplied from the six image lines at a time into different six signal lines, whereby an image signal of the XGA standards is written into said pixels arranged in a matrix through the totaling 12 image lines.

5. A driving method for a display apparatus which includes a panel including a plurality of gate lines extending along rows, a plurality of signal lines extending along columns, a plurality of pixels arranged in a matrix at intersecting points at which said gate lines and said signal lines intersect with each other, and a plurality of image lines separated into two or more systems for supplying an image signal, a vertical driving circuit connected to said gate lines for successively selecting the rows of said pixels, a plurality of sampling switches disposed for connecting said signal lines to said image lines, and a horizontal driving circuit operable in response to a clock signal for successively generating sampling pulses to successively drive said sampling switches so that the image signal is successively written into the pixels of the selected row, comprising the steps of:
grouping said sampling switches into a first group wherein the sampling switches are disposed at intervals and a second group wherein the sampling switches are disposed in a relationship offset by a one-switch distance from the sampling switches which belong to said first group;
connecting the image lines of a first one of the systems to the sampling switches of the first group and connecting the image lines of a second one of the systems to the sampling switches of the second group;
distributing a train of the sampling pulses successively outputted from said horizontal driving circuit alternately to the sampling switches which belong to the first group and the sampling switches which belong to the second group to form a first pulse train and a second pulse train, respectively; and
setting the sampling pulses in the first pulse train and the second pulse train such that adjacent ones of the sampling pulses in the first pulse train are non-overlapping sampling pulses and adjacent ones of the sampling pulses in the second pulse train are non-overlapping sampling pulses and securing a sufficient pulse width for the sampling pulses in the first and second pulse trains so that the image signal is sampled appropriately.
